(19) United States
(12) Patent Application Publication
(10) Pub. No.: US 2012/0240565 A1
(43) Pub. Date: Sep. 27, 2012

(54) SHIFT CYLINDER, DRIVE DEVICE, WORK MACHINE AS WELL AS METHOD FOR OPERATING A WORK MACHINE

(75) Inventor: Bernhard Schnabel, Starnberg (DE)

(73) Assignee: NAF NEUNKIRCHENER ACHSENFABRIK AG, Neunkirchen (DE)

(21) Appl. No.: 13/426,145

(22) Filed: Mar. 21, 2012

(30) Foreign Application Priority Data
Mar. 25, 2011 (EP) 11 159 863.7

(51) Int. Cl. F15B 15/02

(52) U.S. Cl. 60/327; 60/421

(57) ABSTRACT

The invention relates to a shift cylinder including a cylinder element having a working space, a first and a second piston received in the working space displaceably relatively to it, by which the working space is divided in a first working chamber capable of being charged with a working medium through a first port of the shift cylinder, a second working chamber capable of being charged with a working medium through a second port of the shift cylinder and a third working chamber disposed between the first and the second working chamber, including at least one spring member capable of being supported on the first piston on the one hand and on the second piston on the other hand.

### BACKGROUND OF THE INVENTION

The invention relates to a shift cylinder, a drive device of the type specified in the preamble of claim 10, a work machine as well as a method of the type specified in the preamble of claim 16 for operating a work machine.

DE 44 04 829 A1 discloses a power shift transmission for mobile construction and work machines with at least two hydraulic motors capable of being driven via at least one pump, which are each in operative connection with at least one gear pairing on the input shaft side. The hydraulic motors are connected to each other via a clutch for a first driving range of the construction and work machine for addition of the torques of both hydraulic motors. The power shift transmission further includes a planetary gear including at least one driven shaft, the ring gear of which can be fixed via at least one brake. Therein, for a further driving range following the first driving range of the construction and work machine, at least one of the hydraulic motors is disengageable from the drive shaft of the other hydraulic motor via the clutch and engageable with the ring gear of the planetary gear in force-fit manner via a further clutch in the region of its drive shaft for mechanical addition of the speeds of both hydraulic motors corresponding to the superposition principle. This power shift transmission has a high number of parts and a high complexity.

Moreover, from the mass construction of such transmissions for engaging or disengaging hydraulic motors, it is known to use at least one multi-disk clutch for coupling the hydraulic motors. Therein, the multi-disk clutch is pressurized with a hydraulic medium for coupling the hydraulic motors. Upon a sudden pressure loss, then, unintended and undesired shifting of the multi-disk clutch can occur such that the hydraulic motors for example are suddenly decoupled or coupled to each other. Possibly, this can result in damage to the transmissions and/or the hydraulic motors if corresponding countermeasures are not taken.

### SUMMARY OF THE INVENTION

It is the object of the present invention to provide a shift cylinder, a drive device in particular for a work machine, a work machine as well as a method for operating such a work machine, by which secure coupling and decoupling are allowed with simple means.

These objects are solved by a shift cylinder having the features of claim 1, by a drive device having the features of claim 10, by a work machine having the features of claim 15, and by a method for operating a work machine having the features of claim 16.

The first aspect of the invention relates to a shift cylinder. The shift cylinder according to the invention includes a cylinder element having a working space. In the working space, a first piston is received, which is displaceable relative to the working space, in particular longitudinally displaceable. Further, a second piston is received in the working space, which is also displaceable relatively to the working space, in particular longitudinally displaceable. By the first and the second piston, the working space is divided in a first, a second, and a third working chamber. Therein, the third working chamber is disposed between the first and the second working chamber, in particular in longitudinal extension direction of the cylinder element.

A first port of the shift cylinder is associated with the first working chamber, via which the first working chamber can be charged with a working medium, in particular with hydraulic fluid. Thereby, the first piston partially bounding the first working chamber is to be pressurized.

A second port is associated with the second working chamber, which is spaced from the first working chamber via the third working chamber. The second working chamber can also be charged with a working medium, in particular with hydraulic fluid, via the second port. Thereby, the second piston partially bounding the second working chamber can be pressurized.

By charging the first and/or the second piston with the corresponding working medium and thereby with the corresponding pressure, the pistons can be displaced in the working space relatively to it, which involves an increase in volume and decrease in volume of the first and the second working chamber, respectively.

The shift cylinder according to the invention moreover includes at least one spring member, in particular a compression spring, which can be supported on the first piston on the one hand and on the second piston on the other hand. Therein, the spring member is for example disposed in the third working chamber. As a result of the supporting capability of the spring member on the pistons, the spring member can be stressed by moving the pistons relatively to each other, in particular towards each other. By means of the spring member, a spring force of the spring member can be applied bilaterally to the pistons.

A first stop of the shift cylinder is associated with the first piston, by means of which a movement of the first piston towards the second piston is confined. If the first working chamber is charged with the working medium, which involves pressurization of the first piston, thus, the first piston is moved towards the second piston. Therein, as a result of the pressurization, the first piston is moved towards the second piston or can be moved over such a movement path until the first piston gets into supporting abutment on the first stop associated with it. If the first piston is moved into supporting abutment on the first stop, thus, the first piston can no longer be moved further towards the second piston even if the first piston is further pressurized via the working medium.

A second stop of the shift cylinder is also associated with the second piston, by means of which a movement of the second piston towards the first piston is confined. If for example the second working chamber is charged with the working medium, thereby pressurizing the second piston, thus, movement of the second piston towards the first piston is thereby caused. Now, the second piston moves as long or via such a movement path towards the first piston until the second piston gets into supporting abutment on the second stop associated with it. If the second piston is moved into supporting abutment on the second stop, thus, the second piston cannot be moved further towards the first piston even if the second piston is further pressurized via the working medium.

The shift cylinder according to the invention, via which for example a coupling device for coupling the motors of the drive device is shiftable between a first state coupling the motors to each other and a second state decoupling the motors from each other, has a particularly low number of parts and thereby a particularly low complexity. This involves low installation space requirement, a low weight as well as low costs.

Moreover, the shift cylinder according to the invention allows particularly secure shifting of the coupling device and thereby coupling and decoupling of the motors, respectively, since sudden termination of the pressurization of the first or the second piston via the corresponding working medium does not result in an undesired movement of the first piston and/or the second piston in the working space relative to the cylinder element. Thereby, undesired shifting of the coupling device and thereby undesired coupling of the desirably decoupled motors or undesired decoupling of the desirably coupled motors is avoided. Thereby, damage of the coupling device and/or of the motors as a result of the undesired shifting of the coupling device is reliably prevented in all operating states.

In an advantageous development of the invention, it is provided that the shift cylinder is formed for a drive device having at least one motor, in particular for a drive device having at least two motors capable of being coupled to each other for torque addition, in particular for an automotive work machine and/or for a gearshift, a printing machine and/or a transmission device. In other words, the shift cylinder according to the invention is configured such that it is suitable not only for a drive device having at least two motors capable of being coupled to each other for torque addition, for example a drive device of an automotive work machine, but that it can basically also be used for a drive device having only one motor or more than two motors, as well as for all types of gearshifts, printing machines, transmission devices, machine parts and the like, in which restriction of the shift force on the one hand and maintenance of a defined shift state in case of pressure loss on the shift cylinder on the other hand are desirable or required.

For moving the second piston towards the first piston, it is provided that a second force acting on the second piston, which results from the charge of the second piston with the working medium and thereby from a second pressure of the working medium in the second working chamber, is larger than a spring force counteracting the second force and acting on the second piston as a result of the support of the spring member on the second piston on the one hand and on the first piston on the other hand. Therein, the second force and the spring force are greater than a first force acting on the first piston, which optionally acts against the second force from the pressurization of the first piston with the working medium of the first working chamber and thus from a first pressure of the working medium in the first working chamber.

For moving the first piston towards the second piston, inverted force ratios are provided for this. Therein, the first force acting on the first piston as a result of the pressurization of the first piston with the working medium in the first working chamber is larger than the spring force of the spring member, which acts on the first piston as a result of support or capability of supporting of the spring member on the first piston on the one hand and on the second piston on the other hand and which is opposite to the first force. Therein, the first force and the spring force are larger than the second force, which could act on the second piston and thereby against the first force as a result of pressurization of the second piston.

Advantageously, in moving the second piston towards the first piston, the first force and thereby the pressure in the first working chamber is at least substantially zero. For moving the first piston towards the second piston, the second force and thereby the pressure in the second working chamber is particularly advantageously at least substantially zero.

In an advantageous embodiment of the invention, the first piston is supported on the first stop in a shift position of the shift cylinder, wherein a force-applied support of the first piston via the spring member on the second piston is avoided. In other words, in this first shift position, the spring member is not stressed (charged) between the first and the second piston such that the first piston is not moved relatively to the working space by relaxing (discharging) the spring member as a result of cooperation with the second piston in the working space.

If the first chamber is charged with working medium, which involves pressurization of the first piston, and if sudden pressure loss in the first working chamber occurs such that the first piston is charged with a lower pressure or no longer charged with pressure, thus, this sudden pressure loss does not cause a sudden undesired movement of the first piston in the working space relative to the working space. Such undesired relative movement is avoided since as a result of avoidance of the force-applied support of the first piston on the second piston via the spring member, the first piston cannot press on, push on or similarly interact with the second piston.

The first piston remains in its desired position in the working space relative to the working space even upon the sudden pressure loss. Thereby, undesired shifting of the coupling device is avoided. Therein, it is for example provided that the extension of the spring member and of the working space is dimensioned such that the spring member is relaxed and spring force does not act on the first piston in this first shift position of the shift cylinder.

In a further advantageous embodiment of the invention, the second piston is supported on the second stop in a second shift position of the shift cylinder, wherein force is applied to the first piston by supporting the first piston on the second piston via the spring member stressed between the pistons. By pressurization of the second working chamber and thus of the second piston, the second piston is moved up to the second stop towards the first piston. Thereby, the spring member is stressed and charged with the spring force of the spring member. Since the second piston abuts the second stop associated with it, the first piston is only charged with the defined spring force, which is independent of the pressure of the working medium in the second working chamber and thereby independent of the force (second force) acting on the second piston as a result of the pressure. In other words, the first piston only experiences a defined force largely independent of the pressure of the working medium as a result of the spring force. With charge of this force, then, the first piston is for example moved by the second piston in the working space until this movement of the first piston is confined and terminated for example by a further stop, e.g. a wall of the cylinder.

If a pressure loss or pressure drop in the second working chamber suddenly occurs, this does not cause an undesired movement of the first piston in the working space relative to the working space. This means that the first piston maintains at least substantially its desired position in the working space relative to the working space. Only the second piston is moved or displaced in the working space relative to the working space since the second piston is supported with applied force on the first piston via the spring member stressed between the pistons. The second piston is then moved with application of force by the spring member as long or as far until the spring member is relaxed (discharged) and/or until the spring member then gets into supporting abutment on a stop associated with the spring member. This stop associated with the spring member then restricts the relaxation and thus a length variation, in particular an increase in length, of the spring member such that the second piston is not further moved.

This implies that an undesired movement of the first piston in the working space relative to the working space is avoided in the shift cylinder according to the invention even upon a sudden pressure loss of the second working chamber. Thereby, undesired shifting of the coupling device can be avoided with simple and low-cost means.

In a further advantageous embodiment of the invention, the spring member is biased on the first piston. Thereby, it is allowed that the spring member only moves in its desired operating range. A not required operating range between the complete relaxation of the spring member and that longitudinal extension of the spring member, which the first piston is moved for shifting the coupling device in particular for coupling the motors, is biased on the first piston. Thus, the cylinder element can be configured particularly small concerning its longitudinal extension such that the shift cylinder according to the invention has a particularly low installation space requirement. Even with this bias, in the first shift position, force does not act on the first piston as a result of support of the spring member on the second piston such that undesired movement of the first piston upon sudden pressure loss is also avoided with the bias.

For biasing the spring member, the spring member can advantageously be supported on a first support surface disposed on the first piston on the one hand and on a second support surface spaced from the first support surface and disposed on the first piston on the other hand. Thus, the spring member can be biased in a particularly defined manner. Similarly, the cylinder element can thereby be formed particularly small in particular with respect to its longitudinal extension.

Advantageously, the second support surface is formed by a support element, which is supported on the first piston movably relatively to the first support surface for adjusting the bias of the spring member. By this movability of the support surfaces relative to each other, the bias of the spring member can be adjusted to a desired and defined value. This benefits the function satisfaction of the shift cylinder according to the invention and thereby of the entire drive device.

In further development, the first and/or the second stop is disposed outside of the working space. Thereby, the bias of the spring member can be adjusted in particularly simple and adequate manner. In particular, the spring member can also be readjusted after a certain lifetime of the shift cylinder such that the advantageous function satisfaction of the shift cylinder according to the invention is particularly reliably ensured even over a long lifetime.

In a further advantageous embodiment of the invention, the shift cylinder includes a push rod connected to the first piston, which can be moved along with the first piston and which is passed out of the working space via a passage opening of the cylinder element. Thereby, it is possible to shift the coupling device of the drive device in particularly advantageous manner and thus to couple the motors or decouple them from each other via the shift cylinder according to the invention.

The shift cylinder according to the invention is particularly advantageously usable in a drive device, which is formed for an automotive work machine. In particular, in such an automotive work machine, for example, one of the motors provides a high traction force of the work machine, but which only applies to a small range of velocity of the work machine since this first motor is to be operated with only low speeds. The other motor provides in contrast a low traction force of the work machine, but can be operated over a larger range of velocities such that the work machine can also be faster moved than by means of the first motor. The shift cylinder according to the invention therein allows particularly adequate shifting between a first and a second operating state of the work machine, wherein for example the motors are coupled to each other in the first operating state for torque addition and the work machine can be operated with relatively low velocities and a relatively high traction force. In the second operating state, the motors are decoupled from each other such that the work machine can be operated with a relatively low traction force and with relatively high velocities.

The second aspect of the invention relates to a drive device, in particular for an automotive work machine, which includes at least two motors and a coupling device. By means of the coupling device, the motors are coupled to each other for addition of the torques of the motors in a first shift state of the coupling device. In a second shift state of the coupling device, the motors are decoupled from each other.

According to the invention, the drive device includes a shift cylinder according to one of the preceding embodiments, via which the coupling device can be shifted between the shift states. Advantageous developments of the first aspect of the invention are to be considered as advantageous developments of the second aspect of the invention, and vice versa.

Therein, the shift cylinder allows secure shifting of the coupling device between the shift states and avoids undesired shifting of the coupling device from one of the shift states into the other. At the same time, the shift cylinder has only a low complexity and therefore causes only low costs, which benefits a low complexity of the entire drive device and results in considerable cost decreases.

In the first shift state of the coupling device, the torques of the motors are added such that the work machine can be operated with relatively low velocities, but with a relatively high traction force. In the second operating state, the work machine can be operated with relatively high velocities and with a relatively low traction force. Thereby, the work machine is particularly adequately operable.

In an advantageous embodiment of the second aspect of the invention, the first piston is supported on the first stop in the second shift state of the coupling device, wherein a force-applied support of the first piston on the second piston via the spring member is avoided. This means that the second shift state of the coupling device corresponds to the first shift state of the shift cylinder. In this second shift state of the coupling device, the motors are decoupled from each other, wherein the coupling device is opened. As already explained in connection with the shift cylinder according to the invention, undesired relative movement of the first piston in the working space relative to the working space does not occur upon sudden pressure loss in the first working chamber. This means that the sudden pressure loss does not have any influence on the shift position of the shift cylinder and thereby does not have any influence on the shift state of the coupling device. Thus, undesired coupling of the motors does not occur upon the sudden pressure loss, which could possibly damage or even destroy the motors.

In a further advantageous embodiment of the second aspect of the invention, the second piston is supported on the second stop in the first shift state of the coupling device, wherein force is applied on the first piston by supporting the first piston on the second piston via the spring member stressed between the two pistons. If an undesired and sudden pressure loss in the second working chamber occurs, thus, only the second piston is moved relatively to the working space by the relaxing spring member. However, the first piston remains in its desired relative position to the working space such that undesired shifting of the coupling device is prevented even upon a pressure loss in the second working chamber. Thereby, the pressure loss in the second working chamber neither has any influence on the shift position of the shift cylinder and thereby on the shift state of the coupling device.

Moreover, the drive device according to the invention has the advantage that the first piston is charged with a spring force by means of the spring member in the first shift state of the coupling device, that is with closed coupling device, whereby the motors are coupled to each other. Thereby, despite of pressure variations in the second working chamber, variations of a coupling force do not occur, by means of which the motors are coupled to each other via the coupling device in the first shift state. A sudden pressure increase of the pressure in the second working chamber, too, does not result in variation, in particular not in increase, of the coupling force since the movement of the second piston towards the first piston is confined by the second stop. Thus, the second piston cannot move further towards the first piston, cannot still further stress the spring member, and thus not charge the first piston with an even higher force.

In a further advantageous embodiment of the invention, the motors are formed as hydraulic motors capable of being driven by means of a working medium. Thereby, the work machine is operable in particularly efficient, inexpensive manner and with a high traction force.

Advantageously, the drive device only has one pumping device, by means of which both the first working chamber and the second working chamber of the shift cylinder are to be supplied with the working medium. This maintains the number of parts, the installation space requirement, the costs, and the weight of the drive device particularly low.

In further development, the drive device only includes one pumping device, by means of which both hydraulic motors are to be supplied with the working medium. This too, maintains the weight, the number of parts, the installation space requirement and the costs of the drive device according to the invention particularly low.

Preferably, the pumping device, by means of which both hydraulic motors are to be supplied with the working medium, is also the pumping device, by means of which the first and the second working chamber are to be supplied with the working medium. This means that only a single pumping device is provided both for supplying the hydraulic motors and for supplying the first and the second working chamber.

The third aspect of the invention relates to a work machine, in particular a land-based, automotive work machine, which includes a shift cylinder according to the invention and/or a drive device according to the invention. Advantageous developments of the first two aspects of the invention are to be considered as advantageous developments of the third aspect of the invention, and vice versa. Thus, the work machine according to the invention is adequately and safely operable and only has low costs.

The fourth aspect of the invention relates to a method for operating a work machine, in particular of an automotive work machine, which has a drive device including at least two motors and a coupling device. For operating the work machine in a first operating state of the work machine, in the method, the motors are coupled to each other by means of a coupling device such that the torques of the motors are added. For operating the work machine in a second operating state, the motors are decoupled from each other.

In the first operating state, the work machine can for example be operated with a high traction force and with relatively low velocities, while the work machine can be operated with a comparatively lower traction force and with comparatively higher velocities in the second operating state.

According to the invention, the coupling device is shifted between the operating states via a shift cylinder according to the invention. For coupling the motors, the second piston is moved towards the first piston by charging the second working chamber with working medium. Thereby, the spring member between the pistons is stressed. Consequently, the stressed (charged) spring member causes movement of the first piston relative to the second piston away from the second piston. The movement of the second piston is terminated as soon as charging with working medium does no longer occur or as soon as the second piston gets into supporting abutment on the second stop. With coupled motors, the second piston preferably remains in supporting abutment on the second stop.

For decoupling the motors, the first piston is moved towards the second piston by charging the first working chamber with working medium via the first port. Thereby, the spring member between the pistons is stressed. As a consequence, the spring member causes movement of the second piston relative to the first piston away from the first piston. The movement of the first piston is terminated as soon as charging with working medium does no longer occur or as soon as the first piston gets into supporting abutment on the first stop. With decoupled motors, the first piston preferably remains in supporting abutment on the first stop. Advantageous developments of the first three aspects of the invention are to be considered as advantageous developments of the fourth aspect of the invention and vice versa.

The method according to the invention allows shifting between the operating states of the work machine with relatively simple and non-complex means, in particular in the form of the shift cylinder, which involves low costs for performing the method. Further, the method according to the invention avoids an undesired change of the operating states of the work machine as a result of undesired shifting of the coupling device. For example, if a sudden pressure loss in the second working chamber occurs during the first operating state of the work machine, thus, the spring member relaxes, thereby moving the second piston relatively to the first piston away from the first piston. However, the first piston remains at least substantially stationary in the working space such that this pressure drop does not have any influence on the shift position of the shift cylinder.

If a sudden pressure loss in the first working chamber occurs during the second operating state of the work machine, thus, undesired movement of the first piston in the working space relative to the working space similarly does not occur because the first piston is not supported on the second piston with applied force via the spring member in the second operating state. This pressure loss therefore does not result in length variation, in particular extension, of the spring member such that movement of the first piston in the working space relative to the working space is not effected too.

The first operating state of the work machine therein corresponds to the first shift state of the coupling device of the drive device according to the invention and to the second shift position of the shift cylinder according to the invention. Accordingly, the second operating state of the work machine corresponds to the second shift state of the coupling device of the drive device according to the invention and to the first shift position of the shift cylinder according to the invention.

A further advantage is that for shifting the work machine and therefore the coupling device as well as the shift cylinder, only relatively low differential pressures between the first and the second working chamber are required. Thereby, even with relatively significantly varying supply pressure, with which the first and the second working chamber and optionally the hydraulic motors are supplied with the working medium, it can be shifted between the operating states.

The four aspects of the invention are in particular usable in power shift transmissions of an automotive work machine, which is shiftable without traction force interruption between the two operating states. For matching different speeds of the motors, in particular if the motors are coupled to each other, for example, at least one synchronizer ring is provided. By means of the synchronizer ring, respective output shafts of the motors can be taken to an at least substantially identical common speed. Similarly, the four aspects of the invention are also employable in other transmissions, which for example include at least one multi-disk clutch for coupling the motors. Similarly, the four aspects of the invention are advantageously usable in a drive device with at least one clutch, which includes friction elements for coupling the motors, which are to be operated at least substantially always with the at least substantially identical force even with different and varying pressure conditions between the first and the second working chamber. Therein, the pistons are only to be configured corresponding to their dimensions in order to be able to sufficiently stress the spring member even with very low pressures such that the second piston can be moved at least substantially always completely up to the second stop and be brought into supporting abutment on the second stop.

Further advantages, features and details of the invention are apparent from the following description of embodiments as well as based on the drawing. The features and feature combinations mentioned above in the description as well as the features and feature combinations mentioned below in the description of figures and/or shown in the figures alone are usable not only in the respectively specified combinations, but also in other combinations or alone, without departing from the scope of the invention.

### BRIEF DESCRIPTION OF THE DRAWINGS

FIG. 1 is a schematic diagram of a drive device for a land-based, automotive work machine with two hydraulic motors, which is shiftable between a first operating state and a second operating state by means of a coupling device, wherein the hydraulic motors are coupled to each other in the first operating state for addition of the torques of the hydraulic motors and wherein the hydraulic motors are decoupled from each other in the second operating state;

FIG. 2 is a schematic longitudinal section view of the shift cylinder of the drive device according to FIGS. 1; and

FIG. 3 is a schematic longitudinal section view of a further embodiment of the shift cylinder according to FIG. 2.

### DETAILED DESCRIPTION OF THE INVENTION

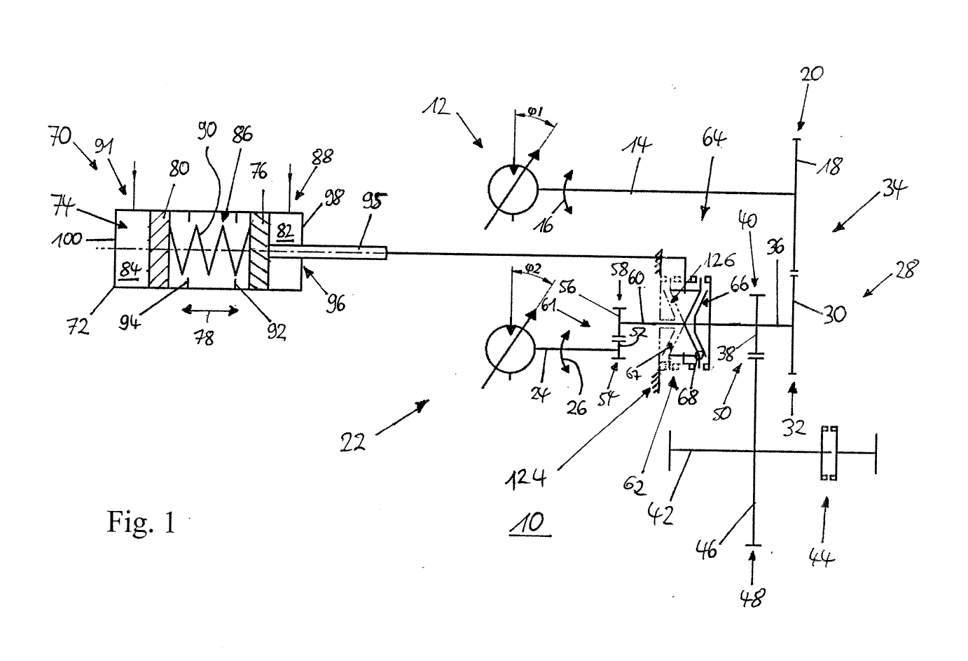

FIG. 1 shows a drive device 10 for an automotive, land-based work machine. The drive device 10 includes a first hydraulic motor 12, which can be driven by means of a hydraulic fluid. The hydraulic motor 12 includes a driven shaft 14, which is rotatable about a rotation axis in a first rotational direction as well as in a second rotational direction opposite to the first rotational direction. This is indicated by a directional arrow 16. A gear 18 is rotationally fixedly connected to the driven shaft 14, which has a toothing 20. The gear 18 is for example formed as a spur gear.

The drive device 10 includes a second hydraulic motor 22, which can be driven by means of the hydraulic fluid. For driving the first hydraulic motor 12 and the second hydraulic motor 22, both hydraulic motors 12 and 22 are to be supplied with the hydraulic fluid by means of only one pumping device of the drive device 10 common to the hydraulic motors 12 and 22. Thereby, the drive device 10 has a low number of parts, a low weight, low costs, and a low installation space requirement.

The hydraulic motor 22, too, has a driven shaft 24. The driven shaft 24 is rotatable about a rotation axis in a first rotational direction as well as in a second rotational direction opposite to the first rotational direction. This is indicated by a directional arrow 26. The drive device 10 further includes a transfer gearbox 28, which can be driven selectively by the first hydraulic motor 12 or by both hydraulic motors 12 and 22.

The first hydraulic motor 12 is permanently coupled to a transfer gearbox 28, which is also referred to as power shift transmission, via the driven shaft 14 and the gear 18. To this, the transfer gearbox 28 includes a gear 30 having a toothing 32. The gear 30, too, can therein be formed as a spur gear. The gears 18 and 30 are engaged with each other via the respective toothings 20 and 32. A gear pair 34 is formed by the gear 18 and the gear 30, wherein the gear pair 34 for example has a gear ratio of at least substantially 0.8. Therein, the toothing 20 for example has thirty-seven teeth, while the toothing 32 has thirty-one teeth.

The gear 30 is rotationally fixedly connected to a shaft 36 of the transfer gearbox 28. Thereby, the shaft 36 is driven by the first hydraulic motor 12 via the gear 30, the gear 18 and the driven shaft 14 and rotated about a rotation axis. Similarly, a gear 38 is rotationally fixedly connected to the shaft 36, which is also rotated by rotating the shaft 36. The gear 38 has a toothing 40. The gear 38 can also be formed as a spur gear.

The transfer gearbox 28 further includes driven shaft parts 42 and 44, which are rotationally fixedly coupled or able to be coupled to wheels of the work machine. Thereby, the wheels coupled to the driven shaft parts 42 and 44 can be driven, whereby the work machine can be driven.

To this, the driven shaft parts 42 and 44 are rotationally fixedly coupled or able to be coupled to a gear 46, which has a toothing 48. Therein, the gear 46 can also be formed as a spur gear. The gears 38 and 46 are engaged with each other via their respective toothings 40 and 48 such that the driven shaft parts 42 and 44 can be driven by the shaft 36 via the gear 46 and the gear 38. A gear pair 50 is represented by the gears 38 and 46, wherein the gear pair 50 for example has a gear ratio of at least substantially 2.3. To this, the toothing 40 for example has twenty-one teeth, while the toothing 48 for example has forty-nine teeth.

The driven shaft 24 of the hydraulic motor 22 is rotationally fixedly connected to a gear 52, which is for example formed as a spur gear and has a toothing 54. A gear 56 having a toothing 58 corresponds to the gear 52, wherein the gear 56 can also be formed as a spur gear. The gear 56 is rotationally fixedly connected to a shaft 60 of the transfer gearbox 28. Therein, the gears 56 and 52 are engaged with each other via their respective toothings 54 and 58 such that the shaft 60 can be driven by the hydraulic motor 22 via the gears 56 and 52 and the driven shaft 24. A gear pair 62 is formed by the gears 52 and 56, wherein the gear pair 62 for example has a gear ratio of at least substantially 2.7. To this, the toothing 54 for example includes nineteen teeth, while the toothing 58 for example includes fifty-two teeth.

The shaft 60 is rotationally fixedly connected or able to be connected to a synchronizer ring 62 of a coupling device 64 of the drive device 10. Therein, the synchronizer ring 62 is movable in axial direction of the shaft 60 relatively to the shaft 60 and for example movably supported on the shaft 60. Thereby, the synchronizer ring 62 is shiftable between two shift states such that the coupling device 64 has two shift states. A first one of these shift states therein corresponds to a first operating state of the work machine, while the second shift state of the coupling device 64 corresponds to a second operating state of the work machine.

The synchronizer ring 62 for example includes at least substantially conical friction elements 66, 67. An at least substantially conical friction element 68, which is rotationally fixedly connected to the shaft 36, corresponds to the friction element 66.

In the second shift position of the coupling device 64, the friction elements 66 and 68 are spaced from each other such that the shafts 60 and 36 are decoupled from each other. This means that the hydraulic motors 12 and 22 are decoupled from each other in the second shift state. The coupling device 64 is opened.

For causing the first shift position and thus for coupling the hydraulic motors 12 and 22 by rotationally fixedly coupling the shafts 36 and 60, the friction elements 66 and 68 are moved relatively to each other in mutual abutment. Since the shaft 36 optionally rotates with a higher speed than the shaft 60 as a result of its coupling to the hydraulic motor 12, the friction elements 66 and 68 allow matching the speeds of the shafts 36 and 60. After matching the speed by means of the synchronizer ring 62, the coupling device 64 can be completely closed (engaged), wherein advantageously transmission of forces and/or torques between the shafts 60 and 36 is effected as a result of positive locking. To this, the coupling device 64 preferably includes at least one claw coupling with claw interlocking, which has undercut teeth. These undercut teeth keep the coupling device 64 always closed under load such that undesired opening of the coupling device 64 under load is avoided.

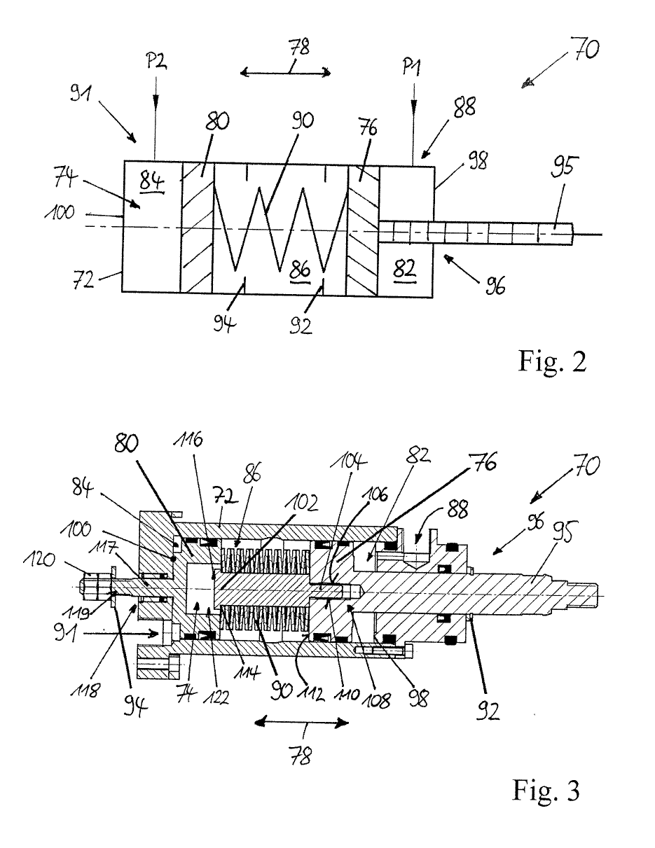

For shifting the coupling device 64 between the first shift state and the second shift state and therefore for allowing shifting of the work machine between the first operating state and the second operating state, the drive device 10 includes a shift cylinder 70. The shift cylinder 70 is also illustrated in FIG. 2 in enlarged manner.

The shift cylinder 70 has a cylinder element 72, by which a working space 74 is bounded. In the working space 74, a first piston 76 is received displaceably in axial direction relatively to the working space 74. This is indicated by a directional arrow 78.

A second piston 80 is also received in the working space 74. The piston 80, too, is displaceable in the working space 74 relatively to the working space 74 in axial direction, which is indicated by the directional arrow 78. By the pistons 76 and 80, the working space is divided in a first working chamber 82, in a second working chamber 84 as well as in third one 86. Therein, the third working chamber 86 is disposed between the first working chamber 82 and the second working chamber 84 in axial direction of the cylinder element 72.

The shift cylinder 70 has a first fluidic port 88 associated with the first working chamber 82, through which the first working chamber 82 can be charged with hydraulic fluid. The shift cylinder 70 further includes a second fluidic port 91, which is associated with the second working chamber 84 and through which the second working chamber 84 can be charged with the hydraulic fluid. Preferably, the working chambers 82 and 84 are to be supplied with the hydraulic fluid via the hydraulic motors 12 and 22 and thus by means of the same pumping device as the hydraulic motors 12 and 22.

Further, the shift cylinder 70 includes a compression spring 90, which is supported on the first piston 76 on the one hand and on the second piston 80 on the other hand and is disposed in the third working chamber 86. By means of the compression spring 90, force can be bilaterally applied to the pistons 76 and 80 by means of a spring force caused by the compression spring 90.

A first stop 92 of the shift cylinder 70 is associated with the first piston 76, by means of which a movement of the first piston 76 towards the second piston 80 is confined. Analogous to this, a second stop 94 is associated with the second piston 80, by means of which a movement of the second piston 80 towards the first piston 76 is confined. The stops 92 and 94 are for example formed by walls of the cylinder element 72 of the shift cylinder 70. The first piston 76 is connected to a push rod 95, which can be moved along with the first piston 76.

Therein, the push rod 95 is passed out of the working space 74 via a passage opening 96 of the cylinder element 72. Further, the push rod 95 is coupled to the synchronizer ring 62 of the coupling device 64 such that by axial movement of the push rod 95, the synchronizer ring 62 can be moved relatively to the shafts 36 and 60 in axial direction thereof.

For closing the coupling device 64, i.e. for causing the first operating state of the work machine, the second working chamber 84 is charged with hydraulic fluid such that a pressure P2 exists in the second working chamber 84, which acts on the second piston 80. From this pressure, depending on an area of the second piston 80, on which the pressure P2 acts, a second force corresponding to the second piston 80 results. Therein, this second force is higher than a spring force optionally acting on the second piston 80 by the compression spring 90 as a result of its support on the first piston 76 as well as larger than a first force corresponding to the first piston 76, which optionally acts opposite to the second force as a result of the charge of the first working chamber 82 with the hydraulic fluid with a pressure P1. Thereby, the second piston 80 is moved towards the first piston 76, until the second piston 80 gets into supporting abutment on the second stop 94.

Thereby, the compression spring 90 is stressed such that the first piston 76 experiences a defined force independent of the pressure P2, which emanates from the stressed compression spring 90. Therein, the force emanating from the compression spring 90 is larger than the optionally acting first force. With this force acting on the first piston and emanating from the compression spring 90, the first piston 76 is moved away from the second piston 80, thereby moving the friction element 66 towards the friction element 68. If the speeds of the shafts 36 and 60 are synchronized, the first piston 76 moves up to its final position in the working space 74 until it is for example supported on an end wall 98 of the cylinder element 72 bounding the working space 74 and the first working chamber 82.

Upon a sudden pressure drop of the pressure P2, the first piston 76 remains in its relative position to the working space 74, while the second piston 80 is moved by the spring force of the compression spring 90 until the compression spring 90 is relaxed and a spring force does no longer act on the second piston 80, respectively. However, the coupling device 64 remains closed. This is in particular realized by the claw interlocking, by which the coupling device 64 at least substantially always maintains its current shift state even upon pressure loss. A further advantage of the shift cylinder 70 is in that at least substantially always the same friction moment is present upon closing (engaging) the coupling device 64 and acts on the coupling device 64 even with different pressures P1 and P2. Therefore, the coupling device 64 can be advantageously and securely closed by a so-called supply pressure of the drive device 10. Since at least substantially always the same constant force is present on the push rod 95 even with different pressures P1 and P2 upon shifting the coupling device 64, an at least substantially always identical friction and synchronization behavior of the coupling device 64 exists.

Thereby, the hydraulic motors 12 and 22 as well as both working chambers 82 and 84 can be supplied with the hydraulic fluid with the supply pressure by a common pumping device, wherein variation of the supply pressure does not result in variation of the friction moment and thereby the friction power of the coupling device 64. This is in particular realized by the spring loading of the first piston 76, wherein it is also allowed by the shift cylinder 70 that the relative position of the first piston 76 to the working space 74 at least substantially does not change upon undesired and sudden pressure loss.

For opening the coupling device 64, i.e. for causing the second operating state of the work machine, the first working chamber 82 is charged with hydraulic fluid such that the pressure P1 exists in the first working chamber 82. This pressure P1 acts on the first piston 76. Depending on an area of the first piston 76, on which the pressure P1 acts, the first force results from the pressure P1, which acts towards the second piston 80. Therein, the first force is larger than a force optionally acting on the first piston 76 by the compression spring 90 opposite to the first force and larger than the second force, wherein the force acting by the compression spring 90 is larger than the second force.

Thus, for engaging, the first piston 76 is moved towards the second piston 80 until the first piston 76 gets into supporting abutment on the first stop 92. Therein, the first force acts at least substantially directly on the push rod 95 and thus on the coupling device 64 without being influenced by the compression spring 90 and its exerted force. By moving the first piston 76 towards the second piston 80, the compression spring 90 is stressed such that a spring force acts on the second piston 80 by the compression spring 90. By this spring force, the second piston 80 is moved towards a further end wall 100 of the cylinder element 72, by which the working space 74 and the second working chamber 84 are partially bounded. The axial extension (length) of the compression spring 90 as well as of the cylinder element 72 and therefore the working space 74 are for example dimensioned such that a spring force does no longer act on the first piston 76 with opened coupling device 64. Thus, a sudden pressure loss of the pressure P1 similarly does not result in undesired movement of the first piston 76 relative to the working space 74 and therefore in undesired shifting of the coupling device 64.

In other words, thus, neither the pressure loss of the pressure P2 nor the pressure loss of the pressure P1 have any influence on the shift state of the coupling device 64 and therefore on the operating state of the work machine.

In the drive device 10, it can be provided that the friction elements 66 and 68 only serve for short-time equalization of the different speeds of the shafts 36 and 60 in engaging. Thus, the friction elements 66 and 68 can be configured particularly small with respect to their dimensions, whereby they in particular can be smaller than for example a multi-disk clutch. A further advantage of the coupling device 64 is that the change of the operating states is allowed without traction force interruption.

FIG. 3 shows a further embodiment of the shift cylinder 70. The shift cylinder 70 according to FIG. 3 includes a piston rod 102 with a threaded shaft 104 having an external thread 106. The first piston 76 has a receptacle 108 corresponding to the screw shaft 104, which is for example formed as a bore. The receptacle 108 is provided with an internal thread 110 corresponding to the external thread 106, in which the screw shaft 104 is screwed at least in certain areas via its external thread 106. Thereby, the piston rod 102 is received in the receptacle 108 of the first piston 76 at least in certain areas.

As is apparent from FIG. 3, the compression spring 90 is biased on the first piston 76 by means of the piston rod 102. To this, the compression spring 90 is supported on a first support surface 112 of the first piston 76 on the one hand and on a support surface 114 of the piston rod 102 on the other hand. Therein, the support surfaces 112 and 114 are spaced from each other in axial direction, wherein the compression spring 90 is biased between the spaced support surfaces 112 and 114. Therein, the support surface 112 is formed by the first piston 76, while the support surface 114 is formed by a collar 116 of the piston rod 102.

By screwing the piston rod 102 into and/or out of the receptacle 108, the distance between the support surfaces 112 and 114 can be adequately adjusted such that the bias and thereby the bias force of the compression spring 90 can also be adequately adjusted and optionally be readjusted.

Therein, the compression spring 90 is biased on the first piston 76 such that it only moves in its operating range. A not required range between completely relaxed compression spring 90 and that length, which is moved for completely engaging, is biased on the first piston 76. This has the advantage that the cylinder element 72 can thereby be formed with a particularly small axial extension. With this bias too, a spring force does no longer act on the first piston 76 in the opened second shift state of the coupling device 64 also with the shorter cylinder element 72.

If the coupling device 64 is closed, thus, the first piston 76 is supported on the end wall 98 and a residual spring force still acts via the second piston 80. However, upon a pressure loss of the pressure P2, the second piston 80 does not spring back the entire way to complete relaxation of the compression spring 90 towards the end wall 100. The second piston 80 only moves a relatively short way until the compression spring 90 gets into supporting abutment on the support surface 114. The spring force of the compression spring 90 is therefore supported by the piston rod 102 and the collar 116.

As is further apparent form FIG. 3, the stops 92 and 94 are disposed outside of the working space 74. Thus, the bias and thereby the compression spring 90 can be adjusted in simple manner and optionally in particular be afterwards readjusted.

To this, the second piston 80 is connected to a rod 117, which is passed out of the working space 74 via a passage opening 118 of the cylinder element 72.

The rod 117 is provided with an external thread 119, onto which counter nuts 120 are screwed. Therein, the counter nuts 120 serve for variably adjusting the bias and therefore the spring force of the compression spring 90.

The second piston 80 has a receptacle 122, in which the piston rod 102 can be received at least in certain areas. Thereby, the second piston 80 can move towards the first piston 76 in particular upon engaging (closing the coupling device 44), wherein the piston rod 102 is moved into the receptacle 122 at least in certain areas. Thereby, the shift cylinder 70 can be formed with a particularly small axial extension.

The drive device 10 further includes an optional braking device 124 with a friction element 126 corresponding to the friction element 67. Therein, the friction element 126 is fixedly supported on a housing part. In the second shift position, in which the friction elements 66 and 68 are spaced from each other, a friction fit is formed between the friction elements 67 and 126 such that the friction elements 67 and 126 are rotationally fixedly connected to each other. As a result of the rotationally fixed connection of the shaft 60 to the synchronizer ring 62 and therefore to the friction element 67, in this manner, the shaft 60 and via it the driven shaft 24 of the hydraulic motor 22 can be retained on the housing part. Thereby, uncontrolled movement of the driven shaft 24 in the second operating state of the work machine is avoided.

It will be understood by those skilled in the art that while the present invention has been disclosed above with reference to preferred embodiments, various modifications, changes and additions can be made to the foregoing invention, without departing from the spirit and scope thereof.

What is claimed is:

1. A shift cylinder (70), comprising:
a cylinder element (72) having a working space (74);
a first and a second piston (76, 80) received in the working space (74) displaceably relatively to it, by which the working space (74) is divided in a first working chamber (82) capable of being charged with a working medium through a first port (88) of the shift cylinder (70), a second working chamber (84) capable of being charged with a working medium through a second port (91) of the shift cylinder (70) and a third working chamber (86) disposed between the first and the second working chamber (82, 84); and
with at least one spring member (90) capable of being supported on the first piston (76) on the one hand and on the second piston (80) on the other hand, by means of which a force can be bilaterally applied to the pistons (76, 80), wherein a first stop (92) of the shift cylinder (70) is associated with the first piston (76), by means of which a movement of the first piston (76) towards the second piston (80) is confined, and wherein a second stop (94) of the shift cylinder (70) is associated with the second piston (80), by means of which a movement of the second piston (80) towards the first piston (76) is confined.

2. The shift cylinder (70) according to claim 1, wherein the shift cylinder (70) is formed for a drive device (10) having at least one motor (12, 22), in particular for a drive device (10) having at least two motors (12, 22) capable of being coupled to each other for torque addition, in particular for an automotive work machine, and/or for a gearshift, a printing machine and/or a transmission device.

3. The shift cylinder (70) according to claim 1, wherein the first piston (76) is supported on the first stop (92) in a shift position of the shift cylinder (70), wherein a force-applied support of the first piston (76) on the second piston (80) via the spring member (90) is avoided.

4. The shift cylinder (70) according to claim 1, wherein the second piston (80) is supported on the second stop (94) in a shift position of the shift cylinder (70), wherein a force is applied to the first piston (76) by supporting the first piston (76) on the second piston (80) via the spring member (90) stressed between the pistons (76, 80).

5. The shift cylinder (70) according to claim 1, wherein the spring member (90) is biased on the first piston (76).

6. The shift cylinder (70) according to claim 5, wherein for biasing the spring member (90), the spring member (90) can be supported on a first support surface (112) disposed on the first piston (76) on the one hand and on a second support surface (114) spaced from the first support surface (112) and disposed on the first piston (76) on the other hand.

7. The shift cylinder (70) according to claim 6, wherein the second support surface (114) is formed by a support element (116), which is supported on the first piston (76) movably relatively to the first support surface (112) for adjusting the bias of the spring member (90).

8. The shift cylinder (70) according to claim 1, wherein the first and/or the second stop (91, 94) are disposed outside of the working space (74).

9. The shift cylinder (70) according to claim 1, wherein the shift cylinder (70) includes a push rod (95) connected to the first piston (76), which is passed out of the working space (74) via a passage opening (96) of the cylinder element (72).

10. The shift cylinder (70) of claim 1, further comprising:
at least two motors (12, 22) and including a coupling device (64), by means of which the motors (12, 22) are coupled to each other for addition of the torques of the motors (12, 22) in a first shift state of the coupling device (64) and are decoupled from each other in at least a second shift state to provide a drive device (10) for an automotive work machine via which the coupling device (64) can be shifted between the two shift states.

11. The shift cylinder (70) of claim 10, wherein the first piston (76) is supported on the first stop (92) in the second shift state of the coupling device (64), wherein a force-applied support of the first piston (76) on the second piston (80) via the spring member (90) is avoided.

12. The shift cylinder (70) of claim 10, wherein the second piston (80) is supported on the second stop (94) in the first shift state of the coupling device (64), wherein a force is applied to the first piston (76) by supporting the first piston (76) on the second piston (80) via the spring member (90) stressed between the pistons (76, 80).

13. The shift cylinder (70) of claim 10, wherein the motors (12, 22) are formed as hydraulic motors (12, 22) capable of being driven by means of a working medium.

14. The shift cylinder (70) of claim 13, wherein the drive device (10) includes only one pumping device, by means of which the hydraulic motors (12, 22) are to be supplied with the working medium and/or by means of which both the first working chamber (82) and the second working chamber (84) are to be supplied with the working medium.

15. The shift cylinder of claim 10, wherein the shift cylinder (70) and drive device (10) are capable of use in a land-based, automotive work machine.

16. A method for operating an automotive work machine with a drive device (10) including at least two motors (12, 22) and a coupling device (64), comprising the steps of:
for operating the work machine in a first operating state, coupling the motors (12, 22) to each other by means of the coupling device (64) for addition of the torques of the motors (12, 22);
for operating the work machine in a second operating state, decoupling the motors (12, 22) from each other;
shifting the coupling device (64) via a shift cylinder (70) between the operating states, by moving the second piston (80) towards the first piston (76) by charging the second working chamber (84) with working medium through the second port (91);
for coupling the motors (12, 22), stressing the spring member (90) between the pistons (76, 80), which as a result moves the first piston (76) away from the second piston (80) relatively to the second piston (80), or moving the first piston (76) towards the second piston (80) by charging the first working chamber (82) with working medium through the first port (88);
for decoupling the motors (12, 22), stressing the spring member (90) between the pistons (76, 80), which as a result moves the second piston (80) away from the first piston (76) relatively to the first piston (76).
